(19) United States
(12) Patent Application Publication
(10) Pub. No.: US 2007/0294580 A1
(43) Pub. Date: Dec. 20, 2007

(54) VIRTUAL TESTER ARCHITECTURE

(76) Inventor: Ziyang Lu, Camas, WA (US)

Correspondence Address: SMITH-HILL AND BEDELL, P.C., 16100 NW CORNELL ROAD, SUITE 220, BEAVERTON, OR, 97006, US

(21) Appl. No.: 11/421,332

(22) Filed: May 31, 2006

(51) Int. Cl. G06F 11/00

(52) U.S. Cl. 714/33

(57) ABSTRACT

A virtual tester, for testing a device logic simulator, includes multiple virtual instruments that generate stimulus messages for delivery to the device logic simulator and for receiving response messages generated by the device logic simulator. Each virtual instrument models a corresponding hardware test instrument and comprises a concrete instrument model that behaves in a manner corresponding to the corresponding hardware test instrument and also comprises an abstract interface that is independent of the behavior of the corresponding hardware test instrument. At least one virtual instrument generates sync messages for coordinating operation of the virtual instruments. A virtual tester engine receives the sync messages and executes an algorithm in which the virtual tester engine cyclically identifies sync messages that pertain to a current operating cycle, communicates sync messages to each virtual instrument, validates sync messages based on responses by the virtual instruments to the sync messages and communicates the validated sync messages to each virtual instrument. A virtual instrument that is specified by a validated sync message performs a test activity based on the validated sync message and a user test program.

### BACKGROUND OF THE INVENTION

This invention relates to a virtual tester architecture.

FIG. 1 illustrates schematically a semiconductor integrated circuit tester for testing an integrated circuit device under test (DUT) 8 in order to determine whether it behaves as expected. The tester comprises multiple test instruments 10 each of which implements multiple tester channels. Each tester channel is connected through a DUT interface structure 12 to a pin of the DUT.

A typical IC tester is cycle based, i.e. it carries out a test in a succession of tester cycles. The start of a tester cycle is defined by an edge of a master clock signal. Prior to the start of a tester cycle, each tester channel receives from a host computer 14 (or internally generates) an instruction defining one or more states that the channel should enter for the tester cycle. A state may be NULL (no test activity) but otherwise the state defines a test activity by specifying an action that the channel is to perform during the tester cycle and the programmable delay time (relative to the clock edge) at which the channel is to perform the specified action. An action may be a stimulus action, in which the channel supplies a stimulus signal to an IC terminal, or an evaluation action, in which the channel evaluates a response signal produced at that terminal. Thus, in one tester cycle a first tester channel might stimulate the device under test by driving a first terminal of the DUT to a desired level at time t1 following the clock edge and a second tester channel might evaluate the response of the DUT to the stimulus by comparing a voltage developed at a second terminal with a selected threshold level at a time t2 following the clock edge (where t1 and t2 are each less than the duration of the clock cycle). That particular tester cycle is then over and the test proceeds with another tester cycle.

In the case of an evaluation action, the channel provides result data specifying the delay time of the evaluation and the result of the evaluation and supplies the result data to a host computer for analysis.

The number of test activities that can occur at a given pin during a given tester cycle is fixed and is typically in the range from one to four, depending on the particular tester. Each pin of a DUT is conventionally described by a pin number. The DUT interface structure typically includes an array of DUT side terminals engaging respective pins of the DUT, an array of tester side terminals connected to terminals of the channels, and a channel relay matrix (not separately shown) connecting each tester side terminal of the DUT interface structure to the proper DUT side terminal, so that each channel of each test instrument is connected to the proper pin of the DUT.

An integrated circuit (IC) designer may develop an IC design by creating an executable program that behaves in a desired way and is commonly referred to as a device logic simulator. The designer uses known techniques to convert the device logic simulator to an IC design that can be implemented in a physical IC device.

In order to enable the physical IC device to be tested using a conventional cycle-based tester, a test engineer creates a test program that generates test data defining the state of each tester channel for each tester cycle having regard to the desired behavior of the device. Before employing the test program to control operation of a physical tester for testing a physical IC device, it is necessary to verify that the test data generated by the test program will appropriately test the device. This is done by using a virtual tester to test the device logic simulator using the test program.

Referring to FIG. 2, the virtual tester is a program that interacts with the device logic simulator through a virtual tester interface. The virtual tester receives the test data for a given tester cycle, and for each channel of the physical tester that is to perform a stimulus or evaluation activity in that cycle, the virtual tester supplies the device logic simulator with parameter values representing the action that the channel is to perform and the programmable delay of the action via the virtual tester interface. The device logic simulator carries out logic operations employing these parameter values and supplies parameter values representing the results of the evaluation activities to the virtual tester via the virtual tester interface. The virtual tester interface converts parameter values provided by the virtual tester to a form acceptable to the device logic simulator and converts the parameter values provided by the device logic simulator to a form acceptable to the virtual tester. If the virtual tester determines that the device logic simulator behaved as expected, it implies that the test data is suitable for testing the physical device.

Traditional cycle-based testers, as shown in FIG. 1, are synchronous, in the sense that all the tester channels operate under control of the same master clock signal and all the test data is defined relative to a common tester clock rate. Conventionally, the virtual tester, the virtual tester interface and the device logic simulator are also cycle based, using the same tester rate. Thus, referring to FIG. 2, the virtual tester and the virtual tester interface operate under control of the master clock MCLK for receiving the test data, providing stimulus parameter values to the device logic simulator, and receiving the result parameter values from the device logic simulator. The device logic simulator carries out its logic operations under control of the same master clock signal.

The conventional synchronous tester that has been described thus far is suitable for testing an IC device that has been designed so that all the circuit elements operate in response to a single clock signal. Such an IC device is said to have a single time domain. When the conventional tester is used to test a device having a single time domain, the tester is operated so that its cycle duration is equal to the period of the device clock signal.

Integrated circuit devices that are commercially available include devices that have multiple time domains. A first group of pins might be connected to circuit elements that operate in response to a master clock signal at a frequency F_{A} and a second group of pins might be connected to circuit elements that operate in response to a master clock signal at a frequency F_{B}. The circuit elements that operate in response to the clock signal at a given frequency are said to constitute a time domain of the device. The circuit elements that are connected to the first group of pins constitute time domain A and the circuit elements that are connected to the second group of pins constitute time domain B.

Current integrated circuit devices that require testing include devices provided with high speed serial (HSS) bus interfaces. These HSS buses are clocked by internal PLLs and accordingly the devices are inherently asynchronous with multiple time domains.

Some emerging testers support testing of IC devices having multiple time domains. In the case of an IC device having two time domains, as described above, the tester would typically employ a first group of tester channels connected to the first group of pins and a second group of tester channels connected to the second group of pins. The test activities conducted by the first group of channels take place in response to a first master clock signal and the test activities conducted by the second group of tester channels take place in response to a second master clock signal. Such a tester is considered to be asynchronous since there is no single tester cycle governing progression of the test activities at the terminals of all the channels. The test data is bounded to the different time domains, in that some portions of the test proceed at the rate of time domain A and other portions of the test proceed at the rate of time domain B.

FIG. 3 illustrates a tester in which each instrument 10 serves a different time domain. Although each instrument 10 operates in its own time domain, it may be necessary for a test activity at one pin of the DUT, in a first time domain, to take place at a predetermined time relative to an activity or event at a pin in a time domain that is served by another of the instruments. In order to support this possibility, the tester includes a ring bus for communicating sync messages among the instruments 10. For example, the user test program specifies to the test instrument 10A that it must wait for a certain condition at a pin served by instrument 10B before taking action. The instrument 10A enters a looping state in which it waits for a sync message to come in. The instrument 10B monitors the state of the pin in question and when the condition specified by the user test program is met, the instrument 10B places a sync message on the ring bus reporting that the condition has been met. The test instrument 10A reads the message on the ring bus and takes action accordingly.

It will be appreciated that the ring bus provides the advantage of flexibility and low cost, but is subject to disadvantage because the sync messages are propagated sequentially from instrument to instrument, resulting in delay and increasing the time required to complete a test. This delay can be reduced by employing a backplane to communicate sync messages directly from a source instrument to a destination instrument, but the backplane is more expensive to implement than a ring bus.

Conventionally, the device logic simulator that is used to create an IC design having multiple time domains and to verify the test data for such an IC device is a single executable program that operates at a uniform rate of progression. Since there is no single tester cycle governing operation of the tester, the device logic simulator cannot run synchronously with the virtual tester. It would in principle be possible to employ an asynchronous communication interface between an asynchronous virtual tester and the device logic simulator but the device logic simulator would then have to deal with each time domain independently. Further, this approach would expose the specifics of the tester's architecture to the device logic simulator. Thus, as new testers were developed, new virtual tester interfaces would be required. However, in order to preserve the value of a virtual tester interface that has been developed for a given device logic simulator, it is desirable that the virtual tester interface should not be dependent on the architecture of the virtual tester. Consequently, it is desirable to employ a synchronous communication interface between an asynchronous virtual tester and the device logic simulator for an IC device having multiple time domains.

U.S. Pat. No. 6,879,927 issued Apr. 12, 2005, the entire disclosure of which is hereby incorporated herein by reference for all purposes, discloses a communication interface for a virtual IC tester that allows a virtual tester to support testing in multiple time domains.

Some testers that are commercially available support instrument plug and play. Mechanical and electrical interfaces are specified for the test head, and any instrument that complies with these interfaces can be placed in the test head in an empty slot and used without need for complex installation procedures.

In order to support flexible use of different instruments in the physical tester, the virtual tester should have an open architecture that supports instrument plug and play.

### SUMMARY OF THE INVENTION

In accordance with a first aspect of the invention there is provided a virtual tester, for testing a device logic simulator, comprising a plurality of virtual instruments that generate stimulus messages for delivery to the device logic simulator and for receiving response messages generated by the device logic simulator, wherein each virtual instrument models a corresponding hardware test instrument and comprises a concrete instrument model that behaves in a manner corresponding to the corresponding hardware test instrument and also comprises an abstract interface that is independent of the behavior of the corresponding hardware test instrument, and at least one virtual instrument generates sync messages for coordinating operation of the virtual instruments, and a virtual tester engine that receives the sync messages and executes an algorithm in which the virtual tester engine cyclically identifies sync messages that pertain to a current operating cycle, communicates sync messages to each virtual instrument, validates sync messages based on responses by the virtual instruments to the sync messages and communicates the validated sync messages to each virtual instrument, and wherein a virtual instrument that is specified by a validated sync message performs a test activity based on the validated sync message and a user test program.

In accordance with a second aspect of the invention there is provided a method of testing a device logic simulator employing a plurality of virtual instruments that generate stimulus messages for delivery to the device logic simulator and for receiving response messages generated by the device logic simulator, wherein each virtual instrument models a corresponding hardware test instrument and comprises a concrete instrument model that behaves in a manner corresponding to the corresponding hardware test instrument and also comprises an abstract interface that is independent of the behavior of the corresponding hardware test instrument, and at least one virtual instrument generates sync messages for coordinating operation of the virtual instruments, wherein the method comprises examining sync messages generated by the virtual instruments and identifying the sync messages that pertain to a current operating cycle of the virtual tester, communicating sync messages to each virtual instrument, validating sync messages based on responses by the virtual instruments to the sync messages, and communicating the validated sync messages to each virtual instrument, and wherein a virtual instrument that is specified by a validated sync message performs a test activity based on the validated sync message and a user test program.

In accordance with a third aspect of the invention there is provided a computer readable medium storing software that, when loaded onto and executed by a computer, implements a virtual teeter for testing a device logic simulator, the virtual tester comprising a plurality of virtual instruments that generate stimulus messages for delivery to the device logic simulator and for receiving response messages generated by the device logic simulator, wherein each virtual instrument models a corresponding hardware test instrument and comprises a concrete instrument model that behaves in a manner corresponding to the corresponding hardware test instrument and also comprises an abstract interface that is independent of the behavior of the corresponding hardware test instrument, and at least one virtual instrument generates sync messages for coordinating operation of the virtual instruments, and a virtual tester engine that receives the sync messages and executes an algorithm in which the virtual tester engine cyclically identifies sync messages that pertain to a current operating cycle, communicates sync messages to each virtual instrument, validates sync messages based on responses by the virtual instruments to the sync messages and communicates the validated sync messages to each virtual instrument, and wherein a virtual instrument that is specified by a validated sync message performs a test activity based on the validated sync message and a user test program.

In accordance with a fourth aspect of the invention there is provided a computer readable medium storing software that, when loaded onto and executed by a computer, implements a method of testing a device logic simulator employing a plurality of virtual instruments that generate stimulus messages for delivery to the device logic simulator and for receiving response messages generated by the device logic simulator, wherein each virtual instrument models a corresponding hardware test instrument and comprises a concrete instrument model that behaves in a manner corresponding to the corresponding hardware test instrument and also comprises an abstract interface that is independent of the behavior of the corresponding hardware test instrument, and at least one virtual instrument generates sync messages for coordinating operation of the virtual instruments, wherein the method comprises examining sync messages generated by the virtual instruments and identifying the sync messages that pertain to a current operating cycle of the virtual tester, communicating sync messages to each virtual instrument, validating sync messages based on responses by the virtual instruments to the sync messages, and communicating the validated sync messages to each virtual instrument, and wherein a virtual instrument that is specified by a validated sync message performs a test activity based on the validated sync message and a user test program.

### BRIEF DESCRIPTION OF THE DRAWINGS

For a better understanding of the invention, and to show how the same may be carried into effect, reference will now be made, by way of example, to the accompanying drawings, in which:

FIG. 1 is a schematic block diagram of a conventional semiconductor integrated circuit tester,

FIG. 2 illustrates in block diagram form the organization of a conventional virtual tester,

FIG. 3 illustrates schematically a conventional semiconductor integrated circuit tester having multiple time domains,

FIG. 4 is a schematic block diagram of a computer on which a virtual tester embodying the present invention may be run, and

FIG. 5 is a block diagram illustrating the organization of a virtual tester embodying the present invention.

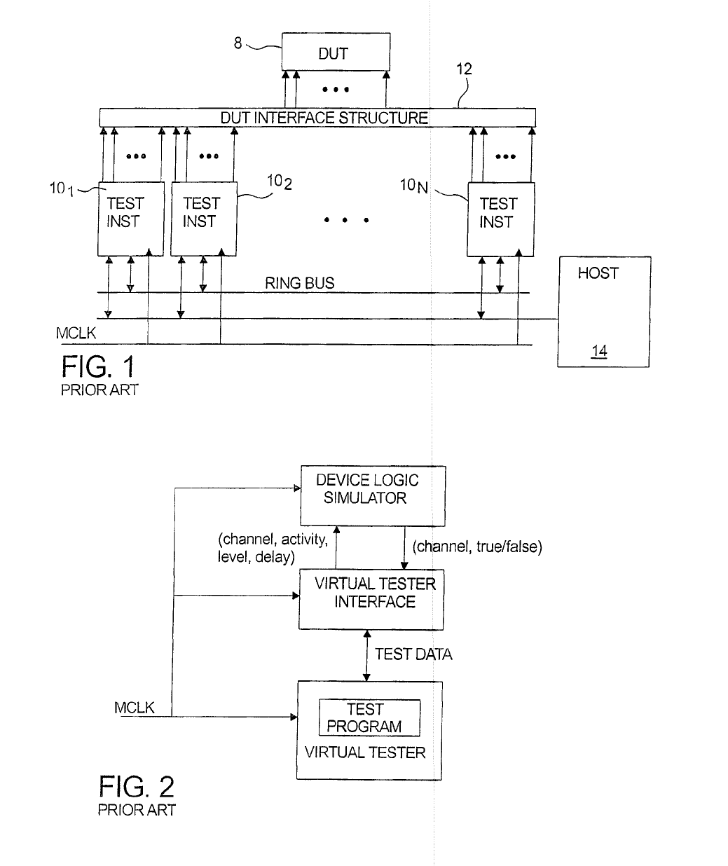

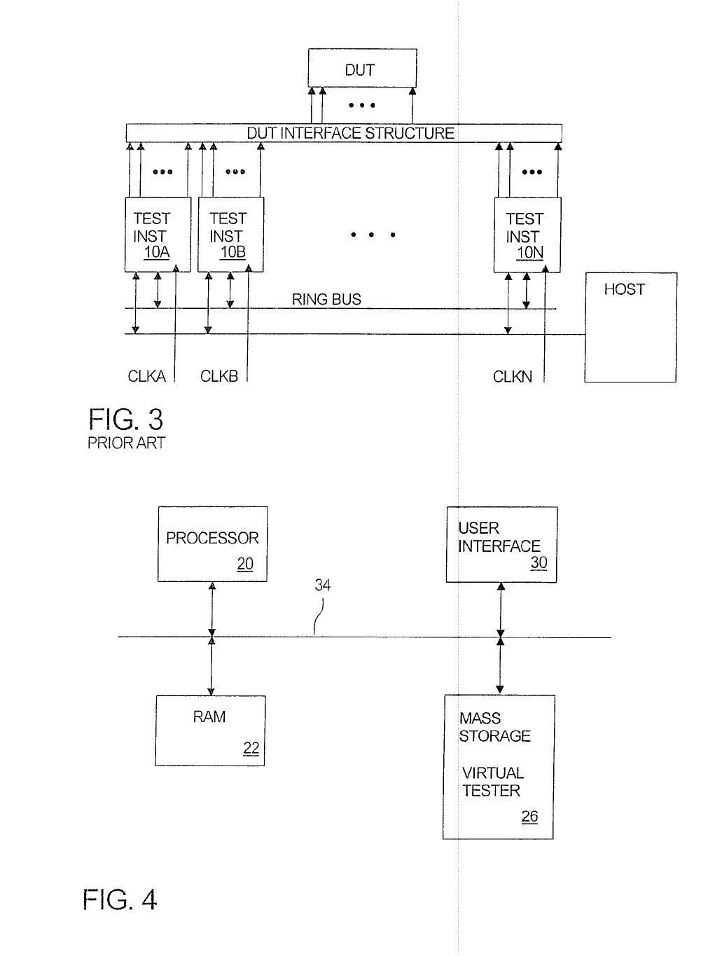

### DETAILED DESCRIPTION

FIG. 4 illustrates a computer comprising a processor 20, program memory 22, mass storage 26, and a user interface 30 (display monitor, keyboard and pointing device). The processor 20, program memory 22, mass storage 26 and user interface 30 communicate over a bus 34. The mass storage, which may comprise one or more fixed disk drives or a CD-ROM, stores the virtual tester embodying the invention. In operation of the computer, at least part of the virtual tester is read from the mass storage and is loaded into the program memory 22 for execution. The virtual tester loads the device logic simulator and also loads the test program, which specifies the test activities to be performed on the device logic simulator.

In order to support instrument plug and play, the virtual tester must accommodate any set of compliant instruments that corresponds to a permitted set of hardware instruments, and it must also ensure independence among the instrument models. Each instrument of the virtual tester is a distinct software process that models the behavior of an instrument of the physical tester. Each instrument model must be self-contained and require no information regarding the behavior of the other instruments or whether any other instrument exists. However, all the instruments must work together to function as a system. For example, depending upon device test requirements, one instrument model may need to wait until another instrument has completed a particular task before proceeding (e.g. a device with HSS buses might have to train the serial ports before running the functional vectors on all the pins). Several instruments may need to detect a device condition together before proceeding (e.g. conditional branching or match loops across pins connected to multiple instruments).

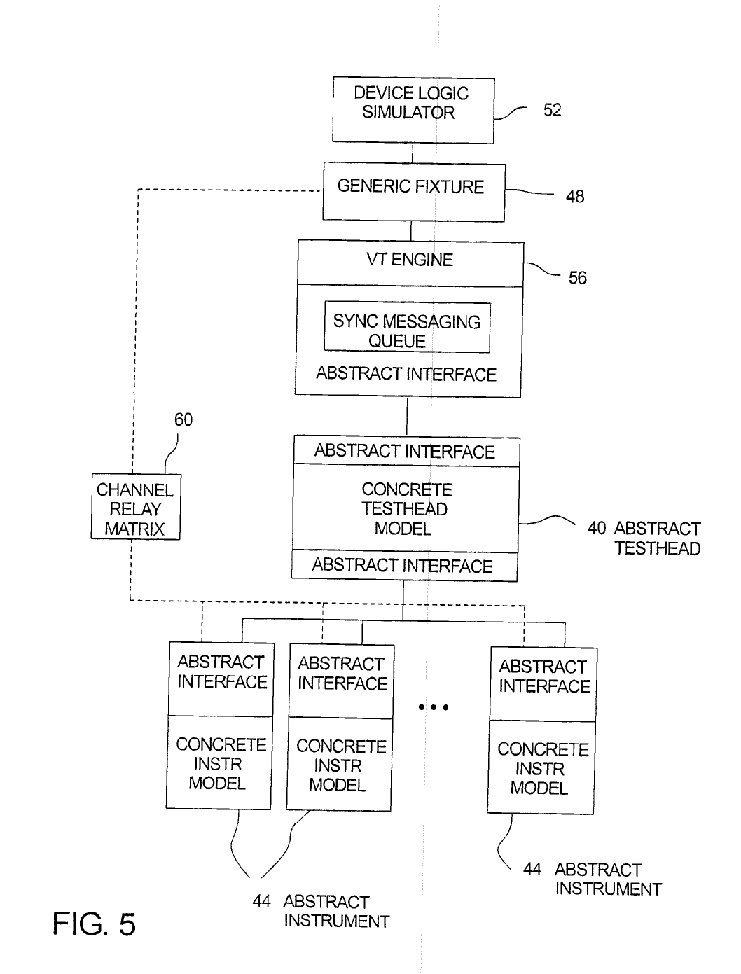

Referring to FIG. 5, a virtual tester embodying the present invention includes several components that, for convenience, are given names that reflect the functions of corresponding components in a physical tester. These components include an abstract test head 40 and multiple abstract instruments 44. The abstract test head is composed of an interface and a model of a selected concrete test head. The abstract interface of the test head allows the abstract test head to issue and receive sync messages respectively to and from the abstract instruments 44. The model of the selected concrete test head emulates the behavior of a physical test head with respect to interfacing with multiple instruments and providing connections among the instruments. For example, a model that emulates a physical test head having a backplane imposes shorter delays on messages being communicated between the instruments than a model that emulates a physical test head having a ring bus.

Similarly, each abstract instrument comprises an abstract interface and a model of a selected concrete instrument. Each abstract instrument has the same abstract interface, which allows the instrument to issue and receive sync messages respectively to and from the abstract test head. The abstract test head functions in conjunction with any abstract instrument that complies with the requirements of the abstract test head, just as a physical test head that supports instrument plug and play is able to accommodate any physical instrument that complies with the mechanical and electrical requirements established for such physical instruments. For example, the abstract test head might issue and receive sync messages having a particular format, and a compliant abstract instrument must accept sync messages in the form issued by the abstract test head and issue sync messages in the form accepted by the abstract test head. Each model of the selected concrete instrument emulates the behavior of a physical instrument. The manner in which the abstract instrument responds to a sync message that it accepts from the abstract test head, or the manner in which the abstract instrument generates a sync message that it issues to the abstract test head, are functionally determined by the concrete instrument and not directly by the abstract test head. Similarly, the manner in which the abstract test head responds to a sync message that it accepts from the abstract instrument, or the manner in which the abstract test head generates a sync message that it issues to the abstract instrument, are functionally determined by the concrete test head itself and not directly by the abstract instrument.

The generic fixture 48 interfaces with the device logic simulator 52 and corresponds to the physical socket that receives the DUT in a physical tester. The generic fixture is a list of channel data structures, one for each pin of the DUT. The data structure for a given pin may contain values to be supplied to the device logic simulator 52 and acted upon by the device logic simulator, or may contain values supplied by the device logic simulator to be transmitted to a channel of an abstract instrument. The device logic simulator may accept messages in the form (pin, activity, level, delay) and issue messages of the form (pin, true/false). Accordingly, the data structures of the generic fixture may store messages of the form (pin, activity, level, delay) or (pin, true/false).

The physical DUT generally has alphanumeric pin names (e.g. A0-A31, D0-D31, etc.). Correspondingly, the device logic simulator has an array of alphanumeric pin indexes corresponding to the pin names of the DUT and the channel data structures of the generic fixture are specified by corresponding alphanumeric pin indexes.

Each physical test instrument has a slot number within the test head and each channel within the test instrument has a number. Each abstract instrument has an index corresponding to the slot number of the physical test instrument and has a local set of numeric channel indexes corresponding to the channel numbers of the physical test instrument. The VT engine 56 orders the alphanumeric pin indexes of the generic fixture alphabetically and assigns consecutive numerical indexes to the pins in the global pin list, and also creates a channel relay matrix 60 that maps the local pin indexes within the abstract instruments to the global pin list in the generic fixture. Thus, the channel relay matrix serves the purpose of the relay matrix in the physical tester in providing communication between a pin of the DUT and the instrument channel that serves the pin.

The test program defines the test to be conducted and is to be validated by the virtual tester. The test program specifies a succession of test activities by referring to (at least) a channel that is to perform the activity, the action that the channel is to perform, and the delay time. The test activity may also refer to a sync condition that must be met before the activity is performed. The test activities and sync conditions are reflected in data that the test program loads into data structures of the virtual tester.

The VT engine 56 defines a common abstract interface for different instrument models and passes messages to and from the instruments. The only interface between the VT engine and other parts of the virtual tester is the abstract interface.

The common abstract interface of the VT engine includes a sync messaging mechanism that allows an instrument model to post sync messages to the VT engine and permits other instrument models to evaluate and act on the sync messages. Thus, the VT engine provides the functionality, in the tester system software, of the ring bus or backplane in the physical tester.

An instrument model generates a sync message containing the following elements:

| | |
|---|---|
| Sync name | a string specifying the name |
| | of the sync message |
| Confirmed flag | a Boolean value specifying |
| | whether the sync is confirmed |
| | by all the source instruments, |
| | used to coordinate several |
| | instruments when any one |
| | instrument can only determine |
| | part of the sync condition |
| Final flag | a Boolean value specifying |
| | whether the sync needs further |
| | adjustment, used for possible |
| | modification by the test head |
| Sync time | a real number in nano seconds |
| | specifying the exact time |
| | since the beginning of test |
| | simulation that this sync |
| | should take effect if the |
| | “final” flag is true |
| Source slot number | an integer number specifying |
| | the slot number of the source |
| | instrument |
| Source instrument type | a string specifying the source |
| | instrument type |
| Sync parameter | an optional string specifying |
| | any extra text that is needed |
| | for the sync |

The action that is to be taken is specified in the test program, and is also part of the hardware instrument design/implementation. Thus, the hardware instrument determines what will happen when the sync condition is met, and this behavior is modeled in the concrete instrument.

This sync message mechanism allows the VT engine to synchronize the instruments without use of specific information regarding the hardware instruments, which would otherwise be difficult because the accuracy and latency requirements differ from tester to tester and the transferred information (format, content) for synchronization differs from tester to tester.

The instrument models generate the proper sync messages and the contents of the sync messages are determined by the user test program and by the hardware behavior (as made available to the abstract instrument by the corresponding concrete instrument model). For example, the sync name is usually defined in the test program (such as a trigger or pattern instruction) but the sync time must incorporate hardware latency (such as the number of pipelines through which the message must propagate in the event that the VT engine emulates a ring bus rather than a backplane).

A sync message does not refer to a destination instrument, because it is necessary that the model of an instrument be independent of other abstract instruments. For example, if a message issued by instrument 3 relates to a condition at pin 1, which is served by instrument 2, the message would refer to pin 1, not to instrument 2. The source instrument posts the sync message to the VT engine, which delivers the sync message to each other instrument. The destination instrument will recognize the sync message and act upon it, while the other instruments will ignore the message. In the case of the example, instrument 2 compares the message to the list of pins served by that instrument, recognizes that it is the destination instrument for the message since it serves pin 1, and acts upon the message.

The VT engine executes an algorithm in a continuous progression from the start of a test to the end of the test, and controls the progression of the algorithm based on virtual tester cycles. For each virtual tester cycle, the VT engine goes through the following steps:
1) In ascending order of slot number, VT engine communicates the current virtual tester cycle period (the time interval relative to the beginning of the test from the beginning of the current virtual tester cycle to the end of the current virtual tester cycle) to each instrument, and asks each instrument to generate sync messages that will take place during this period. The confirmed flag and the final flag of any new sync message are both false. If any, VT engine will add them to the list of messages already in the sync message queue.
2) In ascending order of slot number, VT engine asks each instrument to examine every message in the sync message queue whose “final” flag is false. If an instrument recognizes a sync message that it is partially responsible for and its sync condition is not met, the instrument will change its “confirmed” flag to false for this message. After all the instruments are done, VT engine will remove the messages whose “confirmed” flags are false from the sync message queue.
3) VT engine asks the test head to examine every message in the sync message queue whose “final” flag is false. The test head will adjust the sync time of these messages based on system latency if any (for example, backplane latency or system bus latency), and set their “final” flags to true. For example, if the sync time is N nanoseconds and the system bus latency is B ns, the test head adjusts the sync time to N+B ns.
4) At this point, all the sync messages in the sync message queue are ready to be used. VT engine collects all the messages whose “sync time” is less than the end of the current virtual tester cycle into a separate list, called current sync list. VT engine then removes these sync messages from the sync message queue. The sync messages left in the sync message queue will be used in future virtual tester cycles.
5) In ascending order of slot number, VT engine communicates the current sync list to each instrument, and asks each instrument to generate device stimulus data for the virtual tester cycle. The instruments will process the sync messages along with the data from the user test program. The instruments will store the device stimulus data in the generic fixture via the relay matrix. The device logic simulator reads the device stimulus data from the generic fixture and stores device response data in the generic fixture, and the abstract instruments read the device response data from the generic fixture. When necessary, the instruments will also generate more sync messages that will take effect after this virtual tester cycle.
6) If any, VT engine will add the sync messages generated in step 5 to the list of messages already in the sync message queue.
7) Done with this virtual tester cycle. If this was the last virtual tester cycle, the test is over; otherwise, move on to the next cycle.

Because the concrete test head and concrete instruments communicate through respective abstract interfaces, the concrete test head is not dependent on implementation of the concrete instruments and similarly, the concrete instruments are not dependent on implementation of the concrete test head. Use of abstract interfaces in this manner allows the virtual tester to accommodate any set of compliant instruments, without reference to the concrete test head. Similarly, the concrete test head can be configured to model a physical test head having a ring bus or a backplane without regard to the concrete instruments.

It will be appreciated that the invention is not restricted to the particular embodiment that has been described, and that variations may be made therein without departing from the scope of the invention as defined in the appended claims and equivalents thereof. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated.

1. A virtual tester, for testing a device logic simulator, comprising:
a plurality of virtual instruments that generate stimulus messages for delivery to the device logic simulator and for receiving response messages generated by the device logic simulator, wherein each virtual instrument models a corresponding hardware test instrument and comprises a concrete instrument model that behaves in a manner corresponding to the corresponding hardware test instrument and also comprises an abstract interface that is independent of the behavior of the corresponding hardware test instrument, and at least one virtual instrument generates sync messages for coordinating operation of the virtual instruments, and
a virtual tester engine that receives the sync messages and executes an algorithm in which the virtual tester engine cyclically identifies sync messages that pertain to a current operating cycle, communicates sync messages to each virtual instrument, validates sync messages based on responses by the virtual instruments to the sync messages and communicates the validated sync messages to each virtual instrument,
and wherein a virtual instrument that is specified by a validated sync message performs a test activity based on the validated sync message and a user test program.

2. A virtual tester according to claim 1, further comprising a virtual test head that models a corresponding hardware test head and comprises a concrete test head model that behaves in a manner corresponding to the corresponding hardware test head and also comprises an abstract interface that is independent of the behavior or the hardware test head, and wherein the concrete test head model accepts messages from and transmits messages to, the virtual instruments and communicates messages among the virtual instruments.

3. A virtual tester according to claim 1, wherein the device logic simulator has a plurality of pin indexes and each virtual instrument has a plurality of channel indexes, and the virtual tester further comprises a virtual generic fixture including a plurality of data structures corresponding to the pin indexes respectively, for communicating messages to and from the device logic simulator, and a virtual relay matrix that maps each data structure of the generic fixture to a corresponding instrument channel index for passing messages between an instrument channel and the generic fixture.

4. A virtual tester according to claim 3, wherein the device logic simulator has a plurality of pin indexes corresponding to respective pins of a physical device under test and each virtual instrument has a plurality of channel indexes corresponding to respective channels of the corresponding hardware test instrument.

5. A virtual tester according to claim 2, wherein the virtual tester engine adjusts sync messages based on characteristics of the concrete test head model.

6. A method of testing a device logic simulator employing a plurality of virtual instruments that generate stimulus messages for delivery to the device logic simulator and for receiving response messages generated by the device logic simulator, wherein each virtual instrument models a corresponding hardware test instrument and comprises a concrete instrument model that behaves in a manner corresponding to the corresponding hardware test instrument and also comprises an abstract interface that is independent of the behavior of the corresponding hardware test instrument, and at least one virtual instrument generates sync messages for coordinating operation of the virtual instruments, wherein the method comprises:
examining sync messages generated by the virtual instruments and identifying the sync messages that pertain to a current operating cycle of the virtual tester,
communicating sync messages to each virtual instrument, validating sync messages based on responses by the virtual instruments to the sync messages, and
communicating the validated sync messages to each virtual instrument,
and wherein a virtual instrument that is specified by a validated sync message performs a test activity based on the validated sync message and a user test program.

7. A computer readable medium storing software that, when loaded onto and executed by a computer, implements a virtual tester for testing a device logic simulator, the virtual tester comprising:
a plurality of virtual instruments that generate stimulus messages for delivery to the device logic simulator and for receiving response messages generated by the device logic simulator, wherein each virtual instrument models a corresponding hardware test instrument and comprises a concrete instrument model that behaves in a manner corresponding to the corresponding hardware test instrument and also comprises an abstract interface that is independent of the behavior of the corresponding hardware test instrument, and at least one virtual instrument generates sync messages for coordinating operation of the virtual instruments, and
a virtual tester engine that receives the sync messages and executes an algorithm in which the virtual tester engine cyclically identifies sync messages that pertain to a current operating cycle, communicates sync messages to each virtual instrument, validates sync messages based on responses by the virtual instruments to the sync messages and communicates the validated sync messages to each virtual instrument,
and wherein a virtual instrument that is specified by a validated sync message performs a test activity based on the validated sync message and a user test program.

8. A computer readable medium storing software that, when loaded onto and executed by a computer, implements a method of testing a device logic simulator employing a plurality of virtual instruments that generate stimulus messages for delivery to the device logic simulator and for receiving response messages generated by the device logic simulator, wherein each virtual instrument models a corresponding hardware test instrument and comprises a concrete instrument model that behaves in a manner corresponding to the corresponding hardware test instrument and also comprises an abstract interface that is independent of the behavior of the corresponding hardware test instrument, and at least one virtual instrument generates sync messages for coordinating operation of the virtual instruments, wherein the method comprises:
examining sync messages generated by the virtual instruments and identifying the sync messages that pertain to a current operating cycle of the virtual tester,
communicating sync messages to each virtual instrument, validating sync messages based on responses by the virtual instruments to the sync messages, and
communicating the validated sync messages to each virtual instrument,
and wherein a virtual instrument that is specified by a validated sync message performs a test activity based on the validated sync message and a user test program.
